(19) United States
(12) Patent Application Publication
(10) Pub. No.: US 2009/0213684 A1
(43) Pub. Date: Aug. 27, 2009

(54) Apparatus for distribution of a gas into a body of liquid

(75) Inventor: Jody Michael Bell, Surrey (CA)

Correspondence Address: KLARQUIST SPARKMAN, LLP, 121 SW SALMON STREET, SUITE 1600, PORTLAND, OR, 97204, US

(73) Assignee: Midan Industries Ltd., Langley (CA)

(21) Appl. No.: 12/386,881

(22) Filed: Apr. 24, 2009

Related U.S. Application Data
(63) Continuation-in-part of application No. 11/978,005, filed on Oct. 25, 2007.

(30) Foreign Application Priority Data
Apr. 23, 2009 (CA) 0092543MID02 CAP

(51) Int. Cl. B01F 13/02; B05B 7/10

(52) U.S. Cl. 366/102; 261/79.2

(57) ABSTRACT

A mixing system includes a disc with a plurality of openings combined with a mixer located below the disc with the disc and mixer positioned with respect to one another such that gas exiting openings in the mixer may rise to contact the openings in the disc to sheer the gas into fine bubbles in order to enhance aeration of the liquid.

### FIELD OF THE INVENTION

The present invention relates to an apparatus for aerating and mixing bodies of liquid, and specifically to an improved submersible mixer and associated disk which distribute aspirated gas into the liquid in a large radial pattern in the form of fine bubbles for improved gas transfer rates into the liquid.

### BACKGROUND OF THE INVENTION

Submersible aeration and mixing devices of various configurations have been developed in the past, ranging from simple static devices to complex mechanical machines. All aeration and mixing devices attempt to drive oxygen (usually the form of air) into the body of liquid and to mix the effluent to keep solids in suspension and to distribute the oxygen into the body of liquid. They are commonly used in industrial applications, including in waste water treatment plants to mix and aerate the waste liquids to facilitate digestion of waste in those liquids. It is important in achieving maximum efficiency of the digestion process to provide significant mixing of the waste water liquid and solids contained therein as well as to introduce gasses into the waste water in a manner which facilitates the mixing of the gasses with the waste water. Preferably the mixing device not only causes significant mixing of the liquids and solids, but also introduces the gases into the liquid in fine bubbles to assist in the absorption process with the liquid. The gasses suspended in the liquid is important as oxygen in the suspended gasses (such as air) is used by bacteria and other microscopic organisms in the process of digestion of the waste solids and decomposition of organic matter in the water in order to dean the water.

Many diffused aeration and mixing systems are available and range from course bubble systems to fine bubble systems. Fine bubble systems offer the highest oxygen transfer rates in clean water. However in operation they are rarely used in a dean water environment. These types of diffusers can quickly foul or become clogged in process conditions of unclean water which lower their oxygen transfer rates. Diffused aeration systems require a system of pipes and diffusers mounted in the aeration basin of the tank as well as large blowers or compressors housed above ground in a purpose built facility. When diffusers foul or fail the entire aeration basin must be emptied in order for the diffusers and/or piping to be replaced or repaired. Diffused aeration systems provide some mixing as the diffused gas travels from the diffuser through the liquid to the surface.

Mechanical surface aerators use electric motors to drive a propeller which is located at or very near the surface. These devices lift liquid and forces it against a diffuser plate which creates a 360 Degree spray pattern designed to facilitate gas transfer as the water flies through the air and re-enters the liquid. Compared to diffused aerations systems, surface aerators have much lower gas transfer rates and are very poor mixers. Often installed in lagoon systems surface aerators can be serviced from the surface and can be re-configured without draining the aeration basin.

Self aspirating turbine aerators use a submerged impeller to inject gas (usually air) into a body of liquid while simultaneously mixing the liquid with the gas. Coupled to a hollow shaft, the self aspirating turbine develops a strong vacuum behind each impeller vane as the impeller is rotated at high speeds (such as 1200 RPM). This vacuum draws air down the hollow shaft and ejects it from the spinning impeller at very high velocities. As the air exits the impeller it is subjected to large hydraulic forces which shear the gas into smaller bubbles and the rotation of the impeller creates radial flows which distribute the gas into the body of liquid surrounding the submerged impeller.

However one problem with these types of aerators in practice is the difficulty in controlling the flow of gas from the impeller. These types of devices have a tendency to flood at the high operating speeds required to create a vacuum strong enough to draw gas below the surface of the liquid. Essentially the volume of gas being introduced by the device quickly overcomes the mixing ability of the device and the gas very quickly displaces the surrounding liquid. Within seconds of reaching operating speeds submerged turbine aerators can often flood with gas which prevents radial distribution of gas into the surrounding liquid. There is more gas around the impeller than liquid. Gas continues to be introduced into the liquid at high rates due to the vacuum and can form a narrow vertical stream with a relatively small area of influence and minimal mixing effectiveness. Instead of distributing the gas radially into the liquid the gas travels straight up in the liquid in a column with a small diameter cross-sectional area and with very turbulent stream of gas. As new gas is introduced by the impeller it coalesces with gas already released from the device forming very large fast moving bubbles which are inefficient for gas transfer or mixing in the liquid. This rapid rising column of gas breaks the surface with violent bubbling in close proximity to the rotating hollow shaft.

This causes the efficiency of these types of turbine aerators to be reduced significantly and reduces the usefulness of these types of turbine aerators.

Drawing liquid to the aspirating propeller and directing the flow of gas away is critical to minimizing impeller flooding and to maximizing the gas transfer capabilities of the device.

As a consequence there is a need for an improved aspirating turbine aerator in which the gas can be better controlled in a manner that improves the efficiency of the aspirating turbine aerator in creating fine bubbles of gas exiting the aerator and in mixing those bubbles more efficiently with the liquid.

### SUMMARY OF THE INVENTION

This invention provides a submersible, slotted, rotary disk which, when coupled with a mixer (including an aspirating turbine aerator), improves the dispersal of the air from the mixer by breaking up the gas into finer bubbles as the gas contacts the disk after leaving the mixer and rising in the liquid. The combination of disk and mixer improves gas transfer rates into the liquid by increasing shear thereby creating finer bubbles of gas and strong radial distribution channels in close proximity to the release point of aspirated gas from the mixer.

In one aspect of the present invention a thin rotating disk with slotted vents is coupled above the aspirating propeller for rotation therewith. The disk is designed to contact the gas exiting from the propeller as the gas moves upwardly from the propeller. Liquid from beneath the propeller passes the gas vents of the rapidly spinning propeller which entrains aspirated gas in the liquid and directs it at the slots of the larger diameter rotating disk above. The disk is spinning at the same speed as the propeller and gas entering the slots from the bottom of the disk is rapidly sheared into smaller bubbles as the gas exits the top of the slots. Simultaneously the rotation of the disk in the liquid creates strong radial mixing currents which work to propel the liquid radially away from device.

This radial distribution redirects the primary axial flow from the aspirating propeller and improves mixing, reduces bubble size and vastly improves gas distribution into a liquid when compared to devices without such a disk.

A balance between the volume of gas being released and mixing is important to providing an efficient method for aerating liquids. With this device the balance can be adjusted to suit different applications. Adjustment can be made as needed by changing the operating speed (RPM) of the device, disk diameter, gas flow rate and submergence level of the device to obtain optimal mixing of the gas into the liquid.

In an embodiment of the invention a mixing system for mixing and distributing a gas into a liquid includes a drive shaft connectable to a motor for rotating the drive shaft; a rotatable mixer connected to the drive shaft for mixing the gas and liquid together, the mixer includes a plurality of blades having an upper pitched surface to direct liquid upwardly from the blades, each blade having a passageway having an inlet and an outlet through which gas may flow from the inlet to the outlet and radially outwardly into the liquid; a conduit associated with the drive shaft connected to the inlet for directing gas through the conduit into the inlet; and a rotatable disk connected to the drive shaft positioned above the mixer, the disk comprising a plurality of openings positioned with respect to the mixer such that gas exiting the outlet and rising in the liquid may be contacted by and pass through one or more openings to physically sheer the gas into smaller bubbles.

In further embodiments the conduit may include a hollow section in the drive shaft. The mixer, when rotated, may create a suctional force on the gas in the passageway to cause the gas in the passageway to be drawn out through the outlet. The plurality of opening may be position in relation to the mixer such that at least a portion of the openings are oriented above, and slightly radially outward from, the outlet. The gas may exit from the outlet at an exhaust region of the liquid and the openings may be position so that they are above the exhaust region.

In other embodiments the disk may be circular and extend beyond the outer periphery of the mixer with the openings located adjacent the outer periphery of the disk in concentric alignment. The outside diameter of the disk may be approximately one point four times the outside diameter of the mixer. The openings may include longitudinal slots extending radially from the axis of the disk with approximately the same width as the thickness of the disk.

In alternate embodiments the disk and mixer may rotate at the same speed. The disk may define a plane that is perpendicular to the drive shaft. The blades may have an outer end and the outlet may be located at the outer end. The blades may have a trailing side and wherein the outlet is at the trailing side. The blades may have an outer end with the outlet located at the outer end and the blades may also have a trailing side with a second outlet located at the trailing side.

In other embodiments the plurality of openings may be approximately equally spaced from each other in a generally circular array. The plurality of openings may be radially spaced away an equal distance from the centre of the disk.

In a further embodiment of the invention a method of aspirating a body of liquid with a gas includes the steps of (a) immersing a rotatable mixer and disk combination into the liquid, the mixer including: (i) at least one blade having an upper pitched surface which, when rotated, drives liquid upwardly from the blade and a passageway having an inlet and an outlet; and (ii) the disk positioned above the mixer and comprising a plurality of openings positioned with respect to the mixer such that gas exiting the outlet and rising in the liquid may be contacted by and pass through one or more openings to physically break up the gas into finer bubbles; (b) connecting a source of gas to the inlet; and (c) rotating the mixer and disk such that gas passes from the source of gas into the inlet, through the passageway and out the outlet into the liquid such that the gas is driven radially outwardly from the mixer and rises due to buoyancy forces into the openings.

### DESCRIPTION OF THE DRAWINGS

FIG. 1 is a top plan view of the rotatable disc of the mixing system of a preferred embodiment of the invention;

FIG. 2. is a side view of the rotatable disc of FIG. 1;

FIG. 3 is a side view of the rotatable disc of FIG. 1 taken along 3-3 of FIG. 1;

FIG. 4 is a perspective view of the rotatable disc of FIG. 1;

FIG. 5 is a side view of the mixing system of a preferred embodiment of the invention;

FIG. 6 is a bottom view of the mixing system of FIG. 5;

FIG. 7 is a bottom perspective view of the mixing system of FIG. 5; and

FIG. 8 is a perspective view of the mixing system of FIG. 5 attached to a drive shaft and motor.

### DETAILED DESCRIPTION

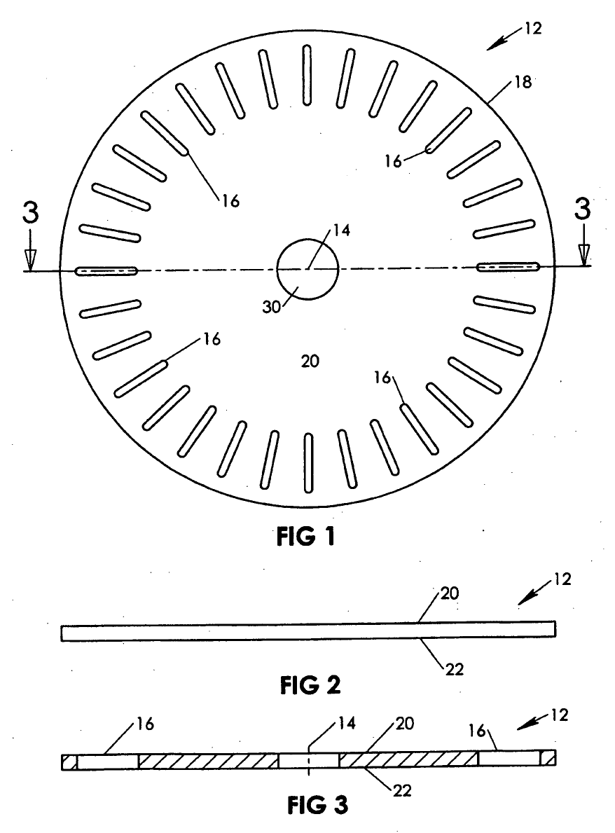

Referring to FIGS. 1 through 4, a rotatable disk 12 is used as a part of a mixing system for mixing in and distributing a gas into a liquid. Disk 12 has a circular circumference with axis of rotation 14 at the centre of disk 12.

A plurality of openings 16 are positioned adjacent outer circumference 18. Openings 16 are generally elongated and capsule shaped extending radially from axis 14. Openings 16 are in concentric alignment with one another about axis 14. Opposed sides of openings 16 are parallel with one another and are perpendicular with the upper and lower faces 20 and 22 of disk 12.

In the preferred embodiment openings 16 are approximately the same width as the thickness of disk 12, that is as compared to the distance between upper face 20 and lower face 22. As well, in a preferred system, the length of each slot is approximately 0.125 times the outer circumference of disk 12. Openings 16 are approximately equally spaced from each other in a generally circular array.

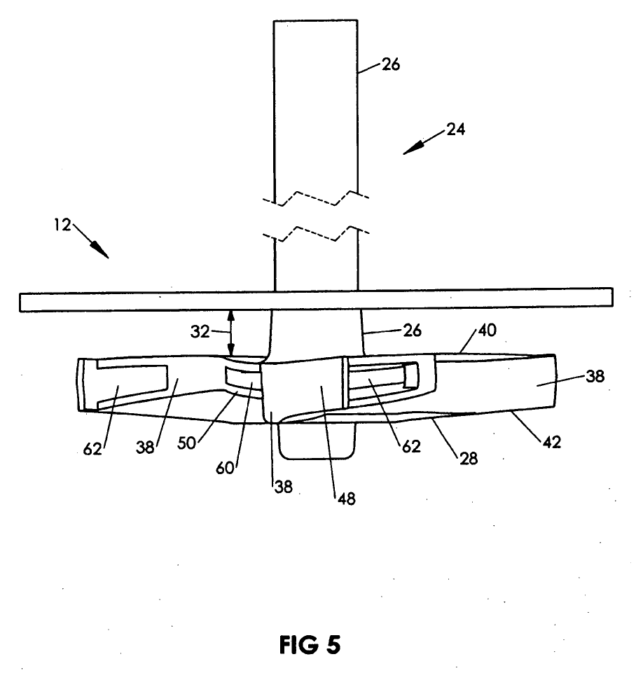

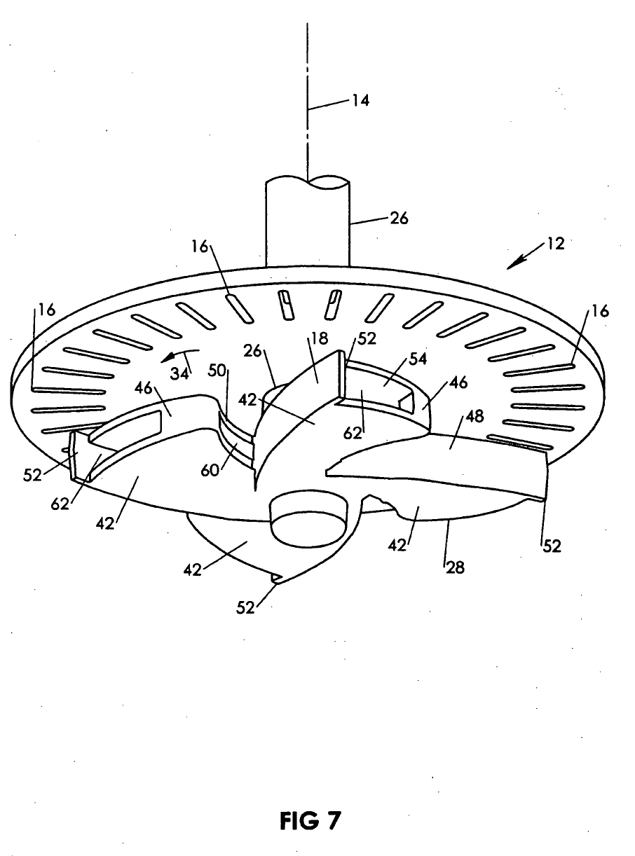

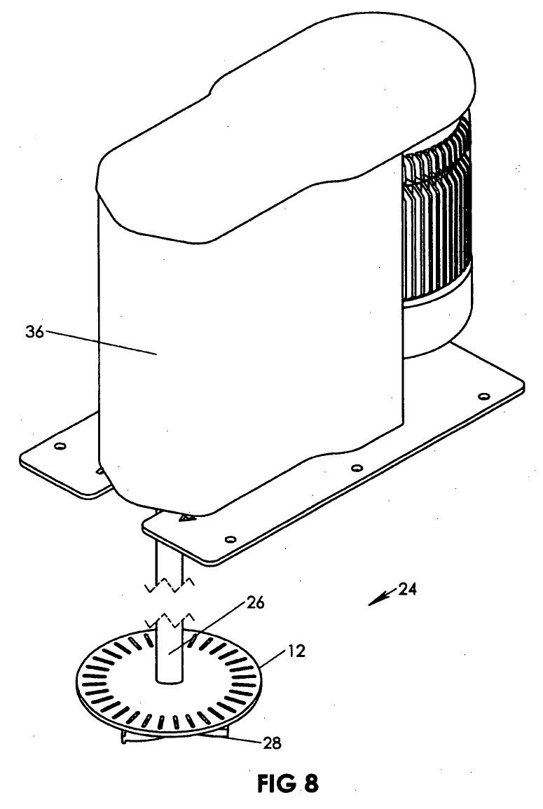

FIGS. 5, 6 and 7 depict disk 12 when in use as a part of the mixing system for mixing and distributing gas into a liquid 24 which is comprised of disk 12, drive shaft 26 and rotatable mixer 28. Mixer 28 may be comprised of a propeller similar to that in my co-pending application Ser. No. 11/978,005. Mixer 28 is designed to mix a gas and liquid together to facilitate mixing and distributing gas into the liquid by mixing system 24. Mixer 28 and disc 12 are attached to shaft 26 in a manner which imparts rotational motion on disc 12 and mixer 28 on rotation of shaft 26. As mixer is designed to rotate in the direction of arrow 34, driveshaft 26 will also be driven by a motor system 36 (FIG. 8) in the direction of arrow 34. The rotation of driveshaft 26 in this direction will also cause disc 12 to be rotated in the direction of arrow 34.

As seen in FIG. 5 drive shaft 26 is integrally connected to mixer 28 such that mixer 28 rotate on rotation of drive shaft 26. Disc 12 is connected to driveshaft 26 as driveshaft 26 extends through central opening 30 (FIG. 1). Disk 12 defines a plane that is perpendicular to the drive shaft 26. Disc 12 is located above mixer 28 and is spaced apart from mixer 28 a sufficient distance 32 to enable gas exiting from mixer 28 to form bubbles prior to contacting disc 12 as the gas rises from mixer 28 due to buoyancy forces on the gas in the liquid. In the preferred embodiment the distance 32 between mixer 28 and disc 12 is about between 20 and 60 millimetres.

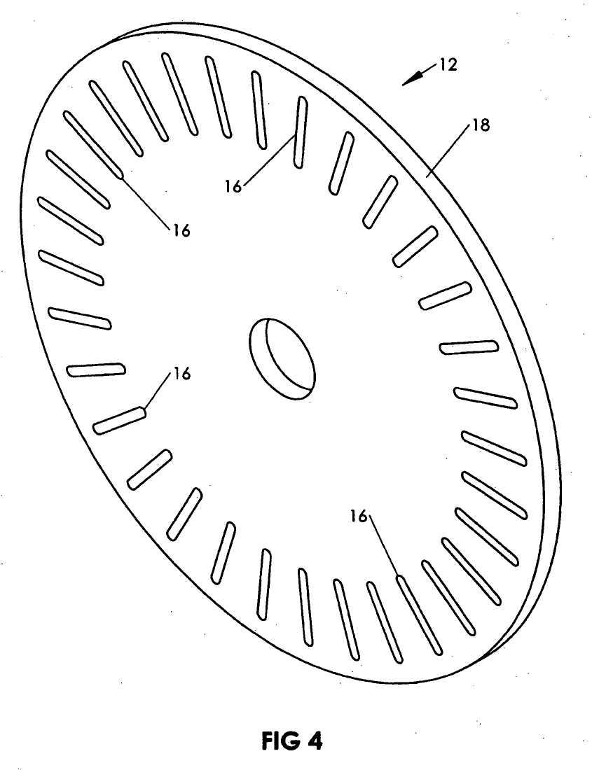

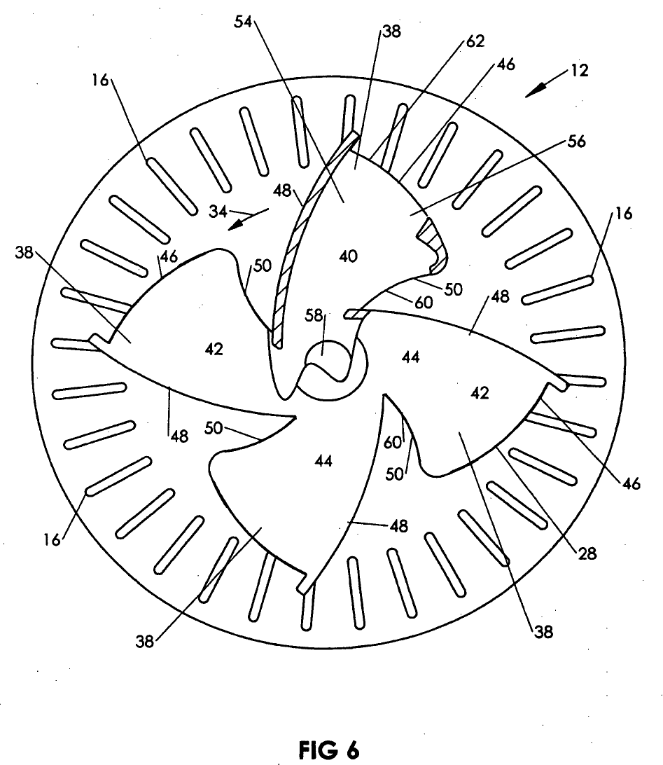

As seen best in FIG. 6, mixer 28 includes four lateral blades 38 arranged symmetrically about axis 14 as seen best in FIG. 3. When viewed from the side as in FIG. 5, blades 38 are generally perpendicular to axis 14, with some modification as discussed below.

Each blade 38 is comprised of upper surface or pressure side 40, lower surface or suction side 42, root section 44, tip 46, leading face 48 and trailing face 50.

Referring to FIG. 6, both leading face 48 and trailing face 50 are curved rearwardly in a direction away from the direction of rotation 34. It can be seen that the degree of curvature of leading face 48 is less than a degree of curvature of trailing face 50. This causes the distance between face 48 and face 50 to be less near root section 44, as compared to tip 46. This creates a relatively bulbous tip 46 of blade 38.

Leading face 48 includes outer extension 52 which extends outwardly beyond tip 46. Extension 52 is an optional component and provides additional impingement against the liquid and the gas exiting from openings 60 and 62, as discussed below.

Referring to FIG. 5, upper surface (pressure side) 40 is angled upwardly from a plane perpendicular to axis 14. This orientation of surface 40 means that upper surface (pressure side) 40 is lower adjacent leading face 48 as compared to trailing face 50. The preferred upward angle between the plane perpendicular to axis 14 and the plane defined by upper surface (pressure side) 26 is about 1.30 degrees. Although a range of upward angles between about 1 and 10 degrees is also suitable.

Lower surface (suction side) 42 is also angled upwardly from the plane perpendicular to axis 14. This orientation of surface 42 means that lower surface (suction side) 42 adjacent leading face 48 is lower than lower surface (suction side) 42 adjacent trailing face 50. The preferred upward angle between the plane perpendicular to axis 14 and the plane defined by lower surface (suction side) 42 is about 6.95 degrees. Although a range of upward angles between about 5 and 17 degrees is also suitable. In a preferred embodiment the upward angle of upper surface (pressure side) 40 is less than the upward angle of lower surface (suction side) 42.

In this embodiment the said angle of lower surface (suction side) 42 is greater than the said angle of upper surface (pressure side) 40 which is a preferred orientation.

The orientation of upper surface (pressure side) 40 and lower surface (suction side) 42 in this manner, with the upward angle of upper surface (pressure side) 40 less than the upward angle of lower surface (suction side) 42, means that the distance between upper surface (pressure side) 40 and lower surface (suction side) 42 is less adjacent trailing face 50 as compared to the distance between upper surface (pressure side) 40 and lower surface (suction side) 42 adjacent leading face 48.

Referring to FIGS. 5 and 6, each of blades 38 is hollow with chamber 54 extending into and connecting with each blade 38 of mixer 28. This is shown by blade 56 of in FIG. 6, which has lower surface 42 removed for ease of reference. It should be understood that in use blade 56 includes a lower surface 42 in the same manner as the other blades 38 of FIG. 6. Shaft 26 is hollow forming conduit 58 therein extending the length of shaft 26. The lower end of conduit 58 connects with each chamber 54 of blades 38 at the inner or axial end of blades 38 (as best depicted with respect to blade 56). Upper end of Shaft 26 is intended to extend above the liquid to permit gas (such as air from the atmosphere) to be drawn into conduit 58, and through conduit 58 into each chamber 54 of blades 38.

Each blade 38 includes two openings connected to chamber 54, a rearward opening 60 and an outer opening 62. Opening 60 is positioned within trailing face 50 and faces rearwardly toward the leading face of a blade 38 of mixer 28 to the rear of blade 38. Opening 60 is rectangular in shape positioned within trailing face 50 with a root section adjacent root section 44 of blade 38.

Opening 62 is positioned within tip 46 facing outwardly from axis 14. Opening 62 is positioned within tip 46 adjacent leading face 48 at one end and with its opposite end near trailing face 50. Opening 62 is generally rectangular in shape although due to the angling of upper and lower surface (suction side)s 40 and 42 as discussed above, opening 62 is somewhat wider at its end adjacent leading face 48 as compared to its opposite end.

Referring to FIG. 6, disk 12 is dimensioned with respect to mixer 28 such that tip 46 and outer opening 62 are positioned generally in vertical alignment with the innermost region of openings 16 of disk 12. Disk 12 is thereby positioned with respect to mixer 28 such that gas exiting opening 62 from chamber 54 may rise in the liquid to be contacted by one or more openings 16 with a portion of the gas pass through openings 16. The gas is thereby physically sheared into smaller bubbles. This facilitates the aeration of the liquid by the gas exiting mixer 28.

Similarly, gas exiting opening 60 also rises upwardly due to buoyancy forces and contacts lower face 22 of disk 12. Because disk 12 is rotating, centrifugal forces cause that gas to move outwardly along lower face 22 until it is contacted by openings 16, thereby providing similar physical shearing of that gas into smaller bubbles as it contacts and/or passes through openings 16.

### Operation

Mixing system 24 is designed to be immersed in a liquid to provide both mixing of the liquid and aerating of the liquid (that is, the introducing air or other gas into the liquid). One useful application is in the mixing and aeration of municipal waste tanks to enhance the breakdown of organic waste by bacteria which need the oxygen in the introduced air to properly digest that material and to multiply. Although the mixing system 24 can be used to introduce and mix various gases (or other fluids such as liquids) in a liquid in which the mixing system 24 is submerged.

As discussed above, mixing system 24 is designed to be rotated in the direction of arrow 34. A suitable motor system 36 (FIG. 8) is connected to mixing system 24 by means of a drive shaft 26 in order to impart that rotational motion on mixing system 24. The drive shaft 26 is hollow to form conduit 58 which is connected to chamber 54.

Upon rotation of mixing system 24 by motor system 36, gas (in the case of aeration, the gas may be air) is either forced down or drawn down conduit 58 of drive shaft 26 into chamber 54. Due to the centrifugal forces on the gas within chamber 54 of each blade 38 of mixing system 24 as it rotates, the gas in chambers 54 of each blade 38 is forced out of openings 60 and 62. Gas exiting chamber 54 through opening 60 exits rearwardly striking the leading face 48 of blade 38 (including optional extension 52 if utilised) of the next rearward blade 38. That leading face 48 (and optional extension 52) contacts the gas exiting opening 60 which splits the gas into fine bubbles to assist in dispersing the gas in the liquid in which mixing system 24 is immersed. Gas exiting chamber 54 through opening 62 exits radially and rearwardly also striking the leading face 48 of blade 38 (including optional extension 52 if utilised) of the next rearward blade 38. That leading face 48 (and optional extension 52) contacts the gas exiting opening 62 which splits the gas into fine bubbles to assist in dispersing the gas in the liquid in which mixing system 24 is immersed.

However at times the gas leaving mixer 28 does not form fine bubbles in this manner. Instead a steady stream of gas may flow upwardly. This is unsuitable for enhancing aeration of the liquid as most of the gas is lost at the surface of the liquid rather than being maintained in the liquid to facilitate digestion. Applicants mixing system 24 provides an advantage with the adoption of disc 12 and its location and orientation with respect to mixer 28.

Gas exiting chamber 54 through opening 62 moves outwardly into the liquid, generally in a radial direction perpendicular to axis 14 to enter an exhaust region generally radially adjacent to tips 46 of blades 38. Buoyancy forces and physical contact with the angled upper surface 40 acting on the gas entering the exhaust region cause the gas to rise and strike disc 12. Because openings 16 are positioned vertically above the exhaust region, at least a portion of the gas will contact openings 16 and either travel through openings 16 or otherwise be contacted by openings 16. This is further facilitated by openings 16 being positioned longitudinally and radially from the axis of rotation of the disk and equally spaced from each other in a generally circular array. This physical contact acts to break up the gas into finer bubbles which enhances the aeration of the liquid with the gas.

Gas exiting through openings 62 also rise upwardly due to buoyancy forces, and due to physical contact with the angled upper surface 40, strike lower surface 42 of disc 12. As disc 12 is rotating centrifugal forces cause that gas to move radially outwardly along surface 42 with at least a portion of the gas contacting openings 16 and either travelling through openings 16 or otherwise be contacted by openings 16. The gas leaving opening 62 is thereby also physically sheered into smaller bubbles to facilitate aeration of the liquid with that gas.

As mixer 28 rotates in the direction of arrow 34, the angle of upper surface (pressure side) 40 creates an additional physical contact with the gas as well as an upward movement of the liquid, in addition to the contact caused by leading face 48. The contact of upper surface (pressure side) 40 with the gas causes the gas to flow axially in a direction generally parallel with that of axis 14, in an upward direction.

The angle of lower surface (suction side) 42 creates a suction beneath blades 38 as mixer 28 is rotated in the direction of arrow 34, which sucks the gas along lower surface (suction side) 28 in a direction from an area adjacent leading face 48 toward and past trailing face 50 which also causes the gas to move generally axially in a direction perpendicular to axis 14 and upwardly from mixer 28. This also provides thrust which makes mixer 28 run more smoothly.

The upward movement of the liquid past mixer 28 further directs the gas to contact openings 16 of disc 12 to physically sheer the gas into smaller bubbles to facilitate aeration.

The angles of upper surface (pressure side) 26 and lower surface (suction side) 28 cause an upward movement of liquid as mixer 28 is rotated. In addition centrifugal forces cause both liquid and exiting gas to move radially from mixer 28. This simultaneous lateral mixing (i.e. radial mixing) and upward mixing (i.e. axial mixing) provides significant benefits as compared to propellers which mix liquid in only one direction, either radially or axially. Mixing is further enhanced due to the positioning of opening 60 with respect to leading face 48 of the following blade 38 which causes gas leaving opening 60 to be struck by leading face 48 to further enhance the mixing process of gas in the liquid further enhancing the operation of mixer 28 to aerate that liquid.

Also beneficial to the mixing of the liquid and mixing of the liquid with the gas is the curvature of leading face 34, which is curved rearwardly in a direction away from the direction of rotation 34. Furthermore, blades 38 at their tip are wider than at their root section to form a bulbous tip. As mixer 28 turns in the direction of arrow 34, the liquid accelerates across leading edge 34 creating an area of high pressure in front of and on top of each blade 38. The curvature of leading edge 34 accelerates the liquid along leading edge 34 outwardly toward extension 52. Liquid is also accelerated across upper surface (pressure side) 26 and lower surface (suction side) 28 of each blade 38 toward tip 46 of each blade 38.

This high pressure stream of liquid accelerates across openings 60 and 62 to create a low or negative pressure area within chamber 54. That negative pressure draws gas down the hollow shaft into chamber 54 and the gas is then flung outwardly by centrifugal force due to the rotation of mixer 28.

It should further be noted that the combination of the perpendicular, relatively blunt, configuration of leading face 34, the generally bulbous tip 46 of blades 38 and the curvature rearwardly of leading face 48 cause the liquid in which the propeller is submerged to travel across blades 38 and along leading face 48 in a manner which creates streams of higher pressure of the liquid in front of and on top of each blade 38. The higher pressure streams of liquid flows past openings 60 and 62 as mixer 28 is rotated in the direction of arrow 34. This creates a region of lower pressure within chamber 54 which draws the gas down the hollow shaft (not shown) through chamber 54 and out openings 60 and 62 into the liquid. This facilitates the dispersing and mixing of the gas with the liquid.

### Alternatives

While this invention has been described as a having a preferred embodiment, it is understood that it is capable of further modifications, uses and/or adaptations of the invention following in general the principle of the invention and including such departures from the present disclosure has come within the known or customary practice in the art to which the invention pertains and as may be applied to the central features herein before set forth, and fall within the scope of the invention and of the limits of the appended claims. As will be apparent to those skilled in the art to which the invention is addressed, the present invention may be embodied in forms other than those specifically disclosed above, without departing from the spirit or essential characteristics of the invention. The particular embodiments of the invention described above and the particular details of the processes described are therefore to be considered in all respects as illustrative or exemplary only and not restrictive. The scope of the present invention is as set forth in the complete disclosure rather than being limited to the examples set forth in the foregoing description.

1. A mixing system for mixing and distributing a gas into a liquid, comprising:
(a) a drive shaft connectable to a motor for rotating the drive shaft;
(b) a rotatable mixer connected to the drive shaft for mixing the gas and liquid together, the mixer comprising a plurality of blades having an upper pitched surface to direct liquid upwardly from the blades, each blade having a passageway having an inlet and an outlet through which gas may flow from the inlet to the outlet and radially outwardly into the liquid;
(c) a conduit associated with the drive shaft connected to the inlet for directing gas through the conduit into the inlet; and
(d) a rotatable disk connected to the drive shaft positioned above the mixer, the disk comprising a plurality of openings positioned with respect to the mixer such that gas exiting the outlet and rising in the liquid may be contacted by and pass through one or more openings to physically sheer the gas into smaller bubbles.

2. The mixing system as described in claim 1 wherein the conduit comprises a hollow section in the drive shaft.

3. The mixing system as described in claim 1 wherein, when rotated, the mixer creates a suctional force on the gas in the passageway to cause the gas in the passageway to be drawn out through the outlet.

4. The mixing system as described in claim 1 wherein the plurality of opening are position in relation to the mixer such that at least a portion of the openings are oriented above, and slightly radially outward from, the outlet.

5. The mixing system as described in claim 1 wherein the gas exits from the outlet at an exhaust region of the liquid and wherein the openings are position so that they are above the exhaust region.

6. The mixing system as described in claim 1 wherein the disk is circular and extends beyond the outer periphery of the mixer and wherein the openings are located adjacent the outer periphery of the disk in concentric alignment.

7. The mixing system as described in claim 6 wherein the outside diameter of the disk is approximately one point four times the outside diameter of the mixer.

8. The mixing system as described in claim 7 wherein the openings comprise longitudinal slots extending radially from the axis of the disk with approximately the same width as the thickness of the disk.

9. The mixing system as described in claim 8 and with the length of each slot approximately 0.125 times the outer circumference of the disk.

10. The mixing system as described in claim 1 wherein the disk and mixer rotate at the same speed.

11. The mixing system as described in claim 1 wherein the disk defines a plane that is perpendicular to the drive shaft.

12. The mixing system as described in claim 1 wherein the blades have an outer end and wherein the outlet is located at the outer end.

13. The mixing system as described in claim 1 wherein the blades have a trailing side and wherein the outlet is at the trailing side.

14. The mixing system as described in claim 12 wherein the blades have a trailing side and a second outlet, and wherein the second outlet is at the trailing side.

15. The mixing system as described in claim 1 wherein the mixer is a propeller driving the liquid and the gas upwardly from the mixer.

16. The mixing system as described in claim 1 wherein the openings are slots aligned longitudinally and radially from the axis of rotation of the disk.

17. The mixing system as described in claim 1 wherein the gas is air and wherein the conduit has an inlet end which extends above the liquid when in use to draw air into the conduit and the passageway.

18. The mixing system as described in claim 1 wherein said plurality of openings are approximately equally spaced from each other in a generally circular array.

19. The mixing system as described in claim 18 wherein said plurality of openings are radially spaced away an equal distance from the centre of the disk.

20. The mixing system as described in claim 1 wherein the distance between the disk and the mixer is between about 20 and 60 millimetres.

21. The mixing system as described in claim 1 wherein the number of blades is four, oriented symmetrically about the axis of rotation of the mixer.

22. A method of aspirating a body of liquid with a gas, comprising the steps of:
(a) immersing a rotatable mixer and disk combination into the liquid,
(i) the mixer comprising at least one blade having an upper pitched surface which, when rotated, drives liquid upwardly from the blade and a passageway having an inlet and an outlet; and;
(ii) the disk positioned above the mixer and comprising a plurality of openings positioned with respect to the mixer such that gas exiting the outlet and rising in the liquid may be contacted by and pass through one or more openings to physically break up the gas into finer bubbles;
(b) connecting a source of gas to the inlet; and
(c) rotating the mixer and disk such that gas passes from the source of gas into the inlet, through the passageway and out the outlet into the liquid such that the gas is driven radially outwardly from the mixer and rises due to buoyancy forces into the openings.
